(19) United States
(12) Patent Application Publication
(10) Pub. No.: US 2004/0216271 A1
(43) Pub. Date: Nov. 4, 2004

(54) Hinge system

(76) Inventor: Robert E. Schott, Cranford, NJ (US)

Correspondence Address: BOURQUE & ASSOCIATES, P.A., 835 HANOVER STREET, SUITE 303, MANCHESTER, NH, 03104, US

(21) Appl. No.: 10/769,839

(22) Filed: Feb. 2, 2004

Related U.S. Application Data
(60) Provisional application No. 60/444,449, filed on Feb. 3, 2003.

(51) Int. Cl. E05D 7/00

(52) U.S. Cl. 16/234

(57) ABSTRACT

A hinge/building system can be easily assembled/disassembled to create numerous layouts of interlocking and pivoting walls/accessories for use as children toys, commercial purposes (e.g., office cubicles, display units, model making), and residential purposes (e.g., changing rooms, shelters, shelves, storage devices). The system includes a plurality of panels connected with at least two clips and a rod. The clips include a cavity (sized to accept the rod) and at least two arms defining a channel sized to accept the edge of a panel. The clips and panels each include an engagement device such as a groove and tab. Clips can be repositioned on a panel edge to accommodate the clips on any other panel edge when assembled with the rod.

### CROSS-REFERENCE TO RELATED APPLICATIONS

This application claims the benefit of U.S. Provisional Application Ser. No. 60/444,449, filed Feb. 3, 2003.

### TECHNICAL FIELD

The present invention relates to a system for constructing structures and more particularly, relates to a hinge system for use with children's toys and games, commercial and residential structures as well as models, and storage and display systems.

### BACKGROUND INFORMATION

There are many hinge systems/building systems and even more applications for them. One application of hinge/building systems is applicable to children's toys. Children often play with dolls, toy action figures, etc., in purchased buildings or in self-styled, free-form rooms constructed from various materials (e.g. corrugated paper play bricks in varying sizes such as 12″ wide×4″ high×3″ deep). Children typically establish play space on a play room floor and lay out a variety of rooms with the bricks and decorate them with toy accessories, furnishings and other gadgets that they have collected from other gifted, purchased and home-made doll or action figure systems. Children may also fashion “buildings” from other objects such a boxes, tubes, bags, etc.

One additional observation of the prior art is that the idea that construction systems have become so engineered that the finished product is confined to a single contraption. Not only do children need adults to help assemble these complex models, their singular function is lost once the parts end up scattered in the big storage box. We have all witnessed children disregard a new, highly-designed toy or play system for a corrugated box that came with a new household appliance on the same day. Imagination fills the box's space and unfettered creativity leads to hours of happy playtime.

Another application of hinge/building systems is for use in commercial and residential situations. It is often desirable to construct temporary or easily modifiable structures in both commercial and residential situations. Some common examples are office cubicles, shelves, hallways, conference rooms, trade and art show display systems, changing rooms, shelters, stage sets, model making, storage containers.

For example, it is often necessary/desirable to easily be able to modify office cubicles in order to compensate for the addition or removal of employees, installation of new equipment, and for general atmospheric changes. While there currently exist many cubicle systems, these systems generally require tools and complex instructions in order to both assemble and disassemble the cubicles. The parts and instructions often become lost while not in use, thus further complicating the process of assembly/disassembly. Moreover, the parts of these cubicle systems often only form fixed angles such as 90-degree angles. This can be a problem especially when the area the cubicle is being installed has an irregular shape or permanent obstructions (e.g., file cabinets, support beams, windows, and the like).

Accordingly, what is needed is a hinge/building system that can be used for children's toys and games and which allows the same kind of whimsical, creative and self-defining playtime by its modularity, simplicity, scalability, flexibility and storability. A hinge/building system is also needed in both commercial and residential purposes such as office cubicles. The hinge/building system should be easily assembled and disassembled without the need of tools, adult supervision (regarding toys/games), or complex instructions.

### SUMMARY

The present invention features a hinge/building system for use as children toy buildings as well as for commercial purposes (e.g., office cubicles, stage sets, art display systems,) and residential purposes (e.g., changing rooms, organizers, shelves, storage containers). According to one embodiment, the present invention features a kit including at least one panel, at least one clip, and at least one rod. Each panel preferably includes a first engagement device disposed proximate at least one edge. The panel may have virtually any shape/dimension, and may also include an opening such as a door or a window.

The clips include a cavity and a base having at least two arms extending outwardly therefrom forming a channel sized and shaped to accept at least a portion of the panel. A distal end of at least one arm also includes a second engagement device adapted to be removably engageable with the first engagement device such that when the panel is disposed within the channel, the clip is secured to at portion of the panel. According to one embodiment, the base defines the cavity. Alternatively, the base may be open to the channel and the cavity is formed by the space between the base and the panel. Once the clip is secured to the panel, the rod (preferably having a head disposed at one end) is slide within cavities of the clips.

The first and the second engagement device may include a magnetic connection or the like, but preferably include a friction connection such as a groove and tab arrangement. In the preferred embodiment, the first engagement device includes the groove and the second engagement device includes the tab. According to this embodiment, the groove is disposed substantially along the entire perimeter of the panel. Alternatively, the first engagement may include a plurality of engagement devices disposed along only a portion of the panel.

According to one embodiment, the channel formed by the arms converges proximate the distal ends of the arms such that when the panel is disposed within the channel, the distal ends of the arms are expanded and create a biasing force against the panel. In yet another embodiment, one of the arms is longer than another arm. The clip may also include at least four arms defining a first and a second arm portion having a first and a second channel respectively. According to one embodiment, the first and the second arm portion are fixed at an angle with respect to each other. Alternatively, the first and the second arm portion may be pivotably disposed with respect to each other.

### BRIEF DESCRIPTION OF THE DRAWINGS

These and other features and advantages of the present invention will be better understood by reading the following detailed description, taken together with the drawings wherein:

FIG. 1A is plan side view of one embodiment of the hinge/building system including a plurality of panels, a plurality of clips, and a rod in a partially unassembled state according to one embodiment of the present invention;

FIG. 1B is a plan side view of the hinge/building system shown in FIG. 1A in an assembled state according to one embodiment of the present invention;

FIG. 1C is a plan side view of another embodiment of the hinge/building system shown in FIG. 1B in an assembled state;

FIG. 2 is a top plan view of the hinge/building system including three panels according to one embodiment of the present invention;

FIG. 3A is a plan side view of one embodiment of the rod according to the present invention;

FIG. 3B is a plan side view of one embodiment of two rods joined together according to the present invention;

FIG. 3C is a plan side view of another embodiment of two rods joined together according to the present invention;

FIG. 4A is an end perspective view of one embodiment of the clip according to the present invention;

FIG. 4B is an end perspective view of another embodiment of the clip according to the present invention;

FIG. 5 is a side perspective view of the clip shown in FIG. 4 in an assembled state according to one embodiment of the present invention;

FIG. 6 is an end perspective view of yet another embodiment of the clip according to the present invention having a plurality of arm segments;

FIG. 7 is an end perspective view of a further embodiment of the clip according to the present invention;

FIG. 8A is a top plan view of the clip shown in FIG. 7 in an assembled state according to one embodiment of the present invention;

FIG. 8B is a top plan view of the clip shown in FIG. 8A in an assembled state including a pin according to one embodiment of the present invention;

FIG. 9 is a top plan view of a further embodiment of the clip according to the present invention shown in an assembled state;

FIG. 10 is a side plan view of one embodiment of the panel shown in FIG. 1;

FIG. 11 is a side plan view of another embodiment of the panel shown in FIG. 1 having a window or opening;

FIG. 12 is a side plan view of yet another embodiment of the panel shown in FIG. 1 having a door; and

FIG. 13 is a perspective view of a further embodiment of the panel shown in FIG. 1 forming a multiple storied structure.

### DETAILED DESCRIPTION OF THE PREFERRED EMBODIMENTS

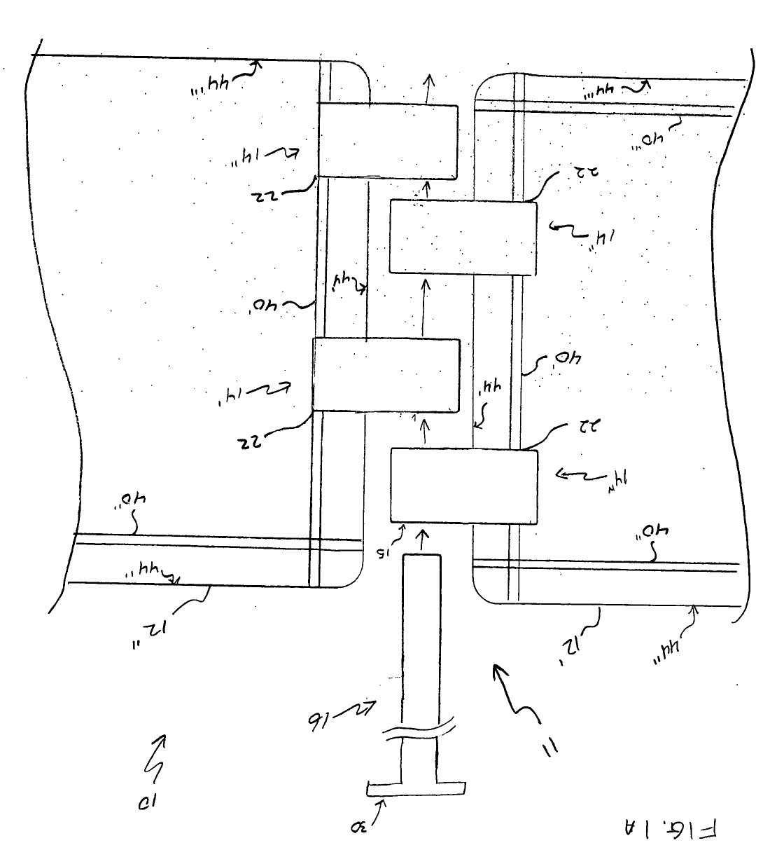

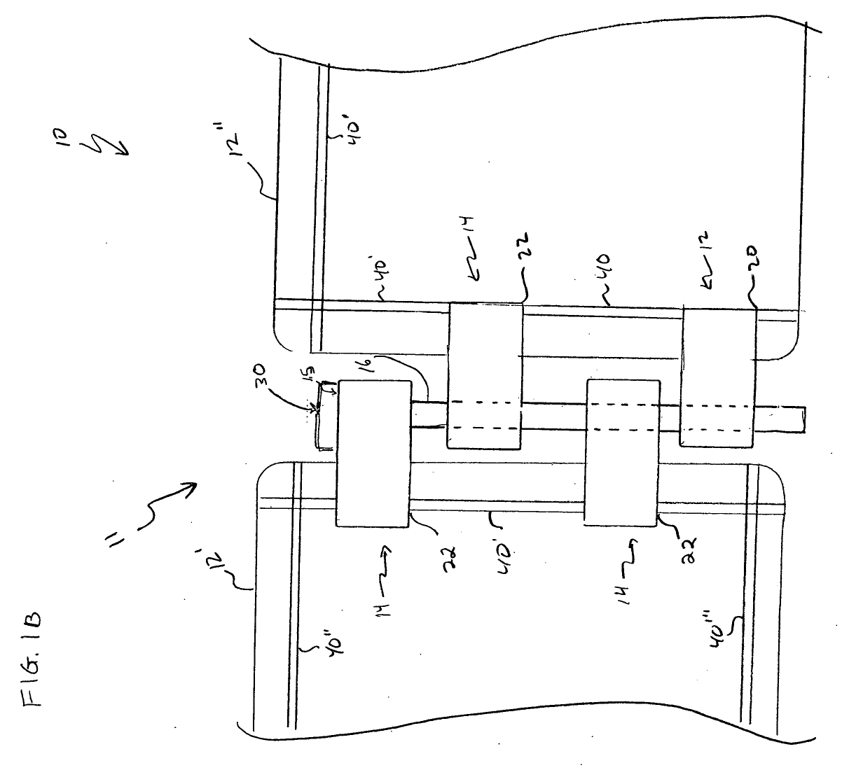

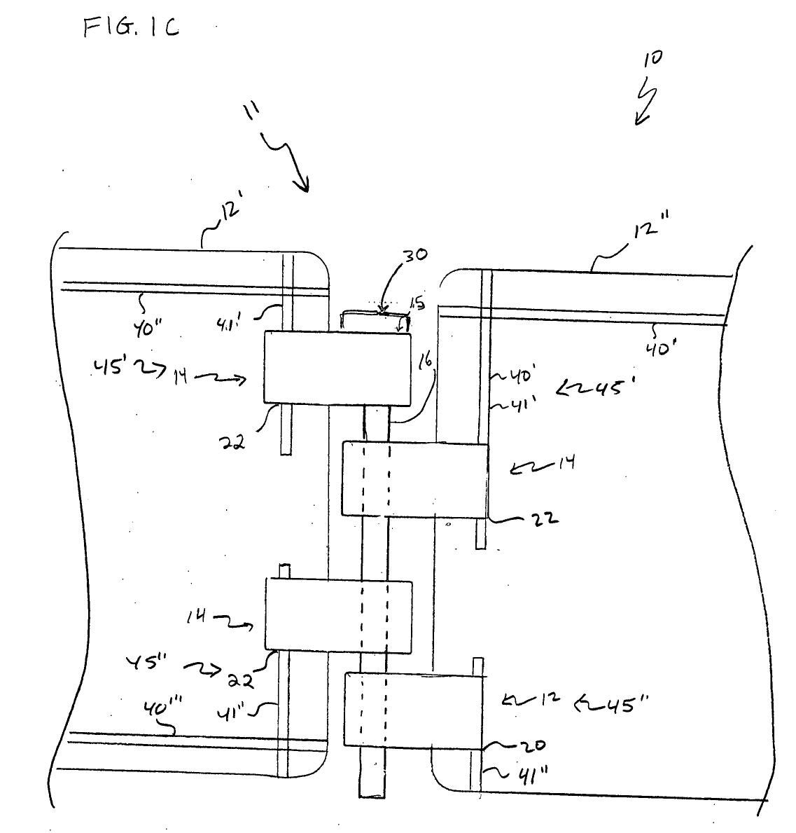

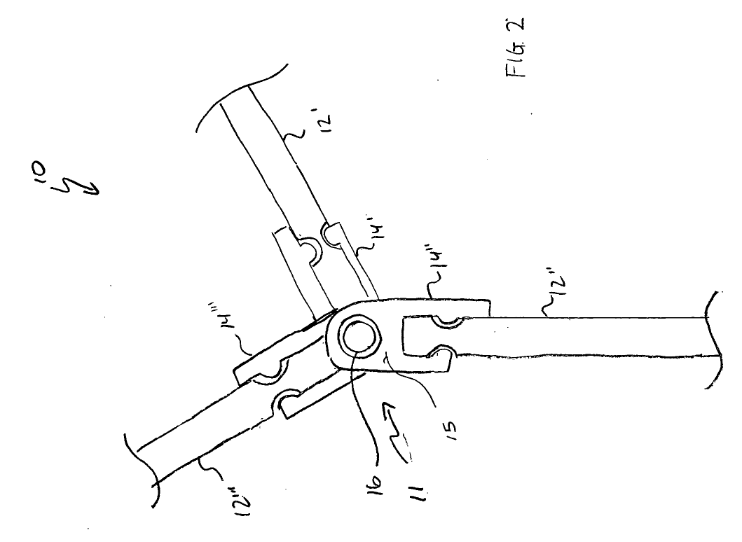

A hinge/building system 10, FIG. 1, according to the present invention, can be easily assembled/disassembled to create numerous layouts and styles of walls and roofs for use as children toy buildings (for example, but not limited to, doll houses, castles, fortresses, etc.) and games (such as, but not limited to, construction type games and mazes) as well as for commercial purposes (for example, but not limited to, office cubicles, hallways, conference rooms, display systems, model making, etc.) and residential purposes (for example, but not limited to, changing rooms, shelves, shelters, storage devices, etc.). The hinge system 10 includes a plurality of panels 12 connected to each other using at least one clip 14 and at least one rod 16. As will be discussed in greater detail hereinbelow, up to approximately six panels 12 can be joined/connected at a single pivot point 11, although joining two, three, or four panels 12 (see FIG. 2) is generally more practical.

The rod 16, FIGS. 1-3, includes a shaft 28 sized and shaped to fit within a cavity/aperture 26 of one or more clips 14 as will be discussed in greater detail hereinbelow. The exact dimensions of the shaft 28 will depend on the size of the panels 12, the number of clips 14 used, as well as the circumstances of the installation and is within the knowledge of one skilled in the art, but is preferably large enough such that the hinge system 10 creates a sturdy connection yet small enough such that the rod 16 is easily removed. According to the preferred embodiment, the shaft 28 includes a cylindrical shape, though other shapes such as, but not limited to, oval shapes, rectangular shapes, triangular shapes, or conical shapes are also envisioned. For exemplary purposes only, the shaft 28 for a child's toy is preferably made from plastic or metal and has a length of about 1″-2″ or 7.5″-15.5″ with a diameter of about 3/16″.

The rod 16 may optionally include a head 30, FIG. 3A, disposed at a first end 31′. The head 30 is sized and shaped to prevent the rod 16 from sliding through the cavity/aperture 26 of the clip. In the preferred embodiment, the head 30 rest on the top surface 15 of the clip 14 and includes a knob 32 sized and shaped to facilitate the installation and removal of the rod 16 from the clips 14. When used as a toy, the knob 32 allows a child to easily grab and pull up and remove the rod 16 from the clip 14.

Alternatively, the first end ends 31′, FIG. 3B, of a first rod 16′ may define a cavity 33 sized and shaped to accept at least a portion of a second end 31″ of an adjacent rod 16″ such that the two rods 16 may be joined to form a single rod 16. In the preferred embodiment, the overall outer size of the rod 16 is substantially constant across the entire length of the rod 16. Alternatively, the first end 31′ may be flared and is within the knowledge of one skilled in the art.

In a further embodiment, adjacent rods 16 may be joined together using a rod connector or joiner 35, FIG. 3C. The rod connector/joiner 35 preferably includes at least one cavity 29, preferably two cavities 29, sized and shaped to accept at least a portion of the ends 31 of adjacent rods 16. While the rod connector/joiner 35 is shown having an outer shape larger than the rods 16, this is not a limitation of the present invention and the ends 31 of the rods 16 may be reduced such that the overall outer size of the rod connector/joiner 35 is substantially constant across the entire length of the joined rods 16.

The clip 14, FIGS. 4-5, is used along with the rod 16 to secure two or more panels 12 together. The clips 14 are preferably made from either plastic or metal and include a plurality of arms or flanges 18 extending from a base 20. The size, shape, and number of clips 14 used at a pivot point 11 depend upon the size, arrangement, and circumstances of the installation and are within the knowledge of one skilled in the art. For exemplary purposes only, the clip 14 is approximately ¾″ in length, ⅜″ in width, and ¼″ in height when used with children's toys.

In the preferred embodiment, the clip 14 includes a first and a second arm/flange 18 which are oriented such that they are generally parallel to each other and form a channel or cavity 21. According to another embodiment, the clip 14 (FIG. 6) includes two or more sets of parallel arms 18 disposed at an angle α relative to each other. The sets of arms 18 may be fixed at a predetermined angle α (such as, but not limited to, 45 degrees, 90 degrees, 180 degrees, 270 degrees, etc.) or alternatively may slide relative to each other such that the angle α may be changed. According to the preferred embodiment, one of the arms/flanges 18′ is preferably longer than the other arm/flange 18″. This arrangement adds stability to the hinge system 10 and facilitates the removal of the clips 14. Alternatively, the arms/flanges 18 may all be the approximately the same length.

The channel/cavity 21 is sized and shaped to accept at least a portion 34 of the panel/wall 12. In the preferred embodiment, the distal ends portions 36 of the arms/flanges 18 are slightly closer to each other than the proximate end portion 37 such the arms/flanges 18 are flexed outwardly in the direction of the arrow A and there is a slight biasing force when the clips 14 are disposed around the portion 34 of the panel/wall 12. This biasing force aids in securing the clip 14 to the panel/wall 12.

The distal and proximate end portions 36, 37 preferably include at least one engagement device 22. The engagement device 22 engages at least one corresponding engagement device 40 disposed on the panel/wall 12.

According to one embodiment, the engagement device 22 includes at least one tab/protrusion 24. In the preferred embodiment, each arm/flange 18 includes at least one tab/protrusion 24, though only one arm/flange 18 may include a tab/protrusion 24. The tab/protrusion 24 is sized and shaped such that at least a portion of the tab/protrusion 24 fits within a corresponding channel/groove/slot 41 of the engagement device 40 of the panel/wall 12. Alternatively, the engagement devices 22, 40, FIGS. 7-8, may be switched such that the clip 14 includes at least one channel/groove/slot 25 and the panel 12 includes at least one corresponding tab/protrusion 42. Other devices and methods of connecting the panel 12 and the clip 14 are also envisioned such as, but not limited to, a hook and loop connection, a magnetic connection, and the like.

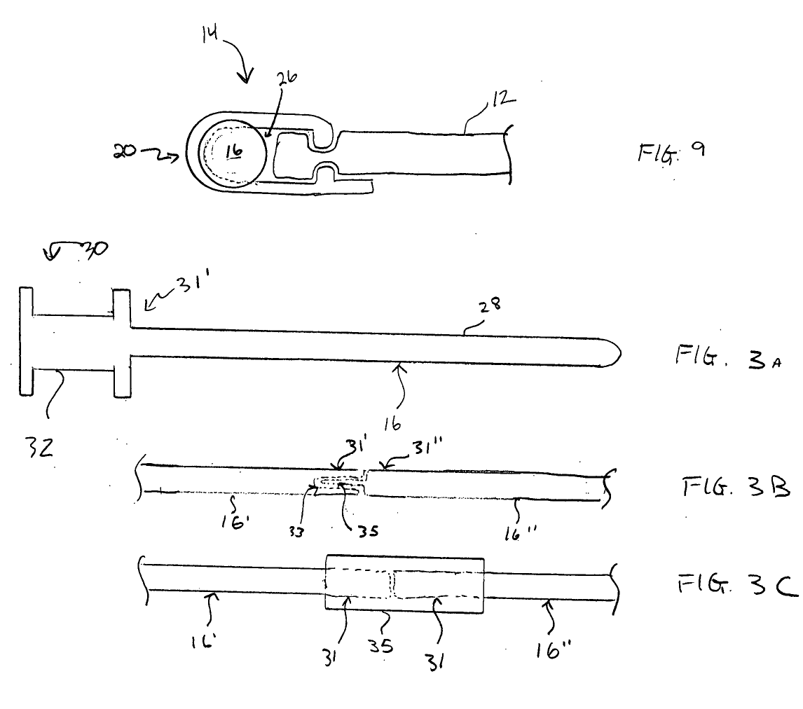

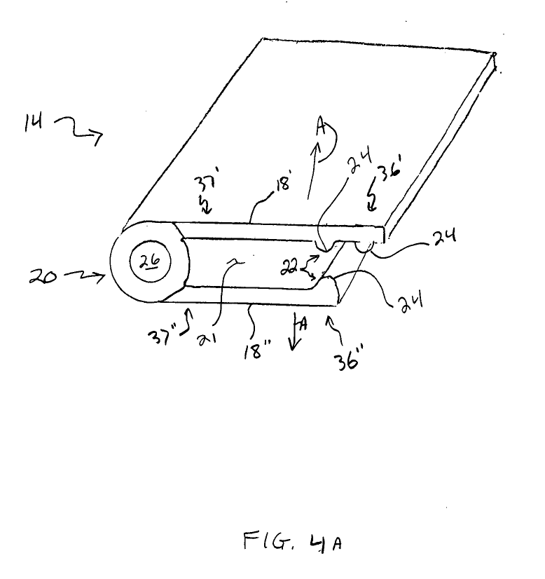

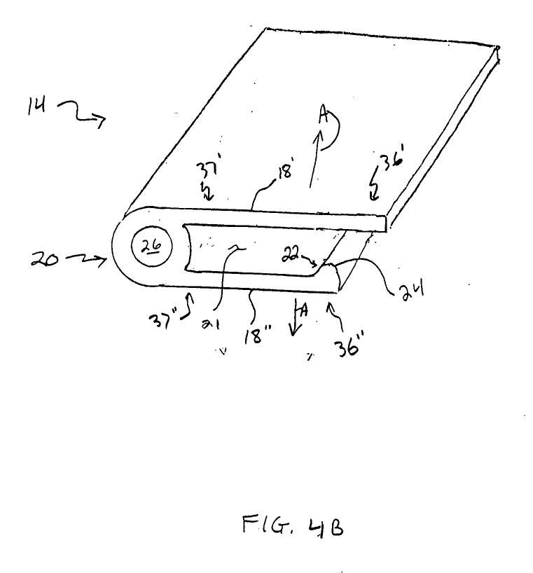

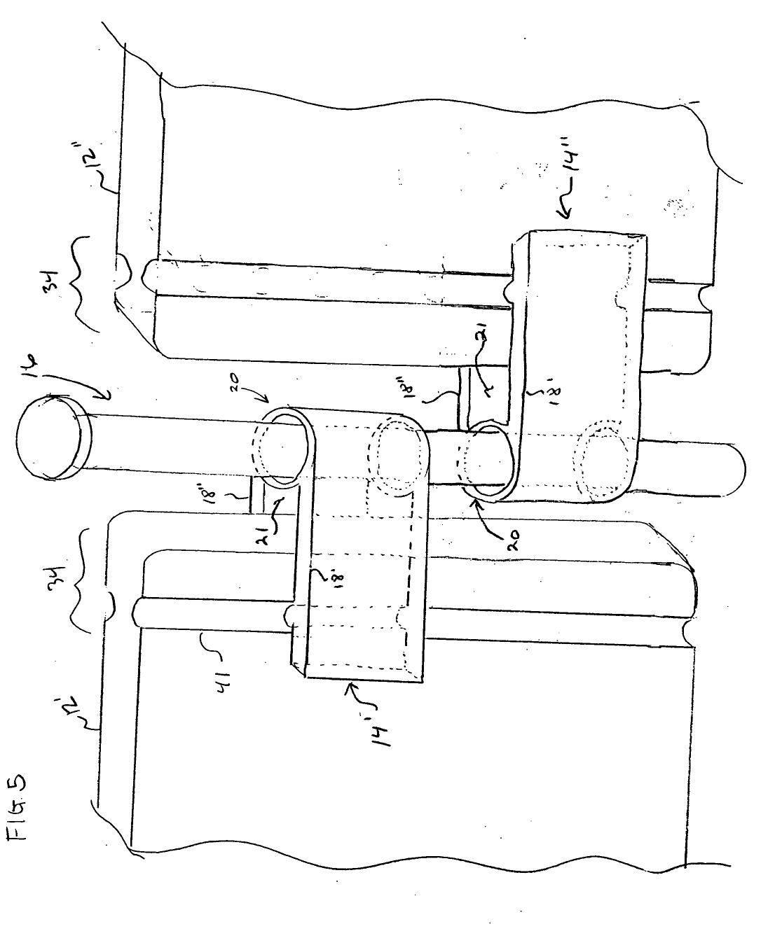

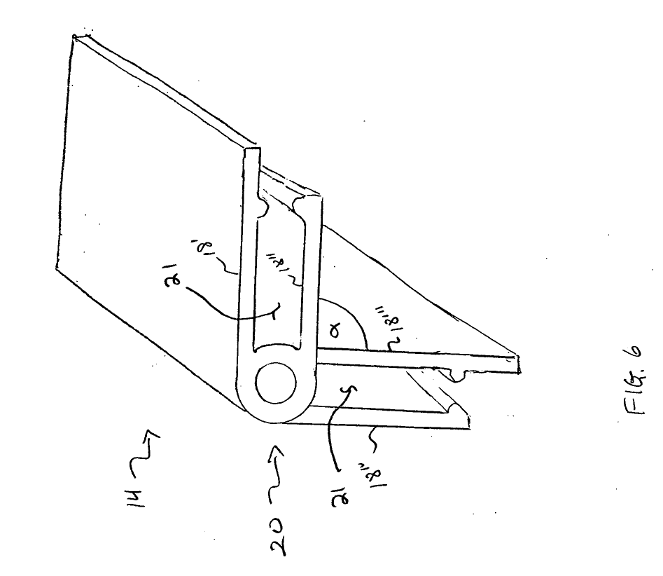

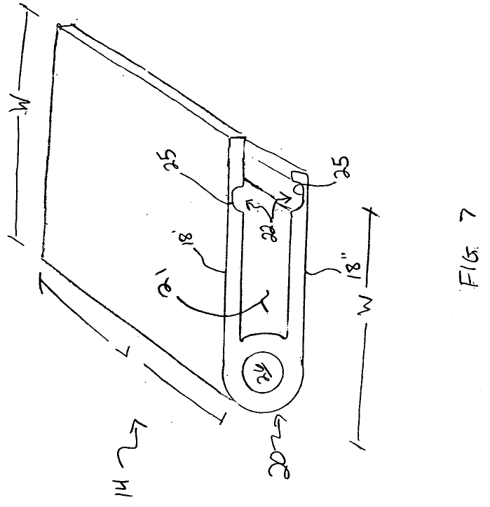

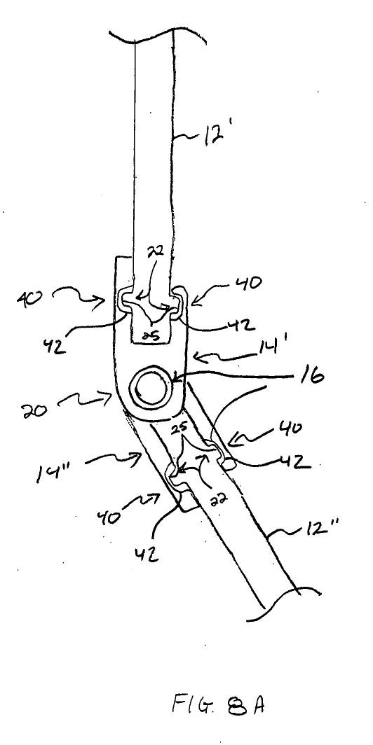

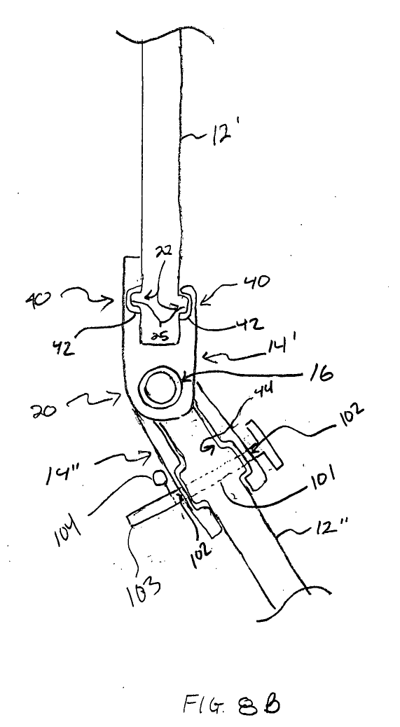

According to the exemplary embodiment, the base 20, FIGS. 4-8, defines a cavity or aperture 26. The cavity 26 is sized and shaped such that at least a portion of the rod 16 fits within it. As discussed above, in the preferred embodiment the head 30 of the rod 16 rests on the top surface 15 of the clip 14 proximate the cavity 26. Alternatively, the base 20, FIG. 9, may be open. According to this embodiment, the rod 16 is slid within the cavity 26 defined by the base 20 and the panel/wall 12.

As discussed above, the panels or walls 12 are connected or joined together using the one or more clips 14 and rods 16. The engagement device 40 of the panels 12 engages with the engagement device 22 of the clips 14 such that the clips 14 are removably secured to the panels 12. Once the clips 14 are secured to the panels 12, one or more rods 16 are slid within the cavity 26 of the clips 14, thereby joining the panels 12 and the clips 14 together.

The engagement device 40 is disposed proximate at least edge 44 and preferably all edges 44 of the panels 12. As discussed above, the exact design of the engagement device 40 depends on the engagement device 22 of the clip 14. In the preferred embodiment, the engagement devices 22, 40 preferably form a friction connection such as, but not limited to, a “groove and tab” style engagement as discussed above. According to this embodiment, the groove 41 is preferably molded proximate the edge 44 of the panel 12 to accept the clips 14 (preferably at least two clips 14). While not a limitation, the panel 12 preferably includes a groove 41 on both the front and back of each panel 12 edge 44. The groove 41 may include either a continuous “groove” (FIGS. 1A-1B) or alternatively may include one or more regions 45′, 45″ (FIG. 1C) having one or more grooves 41′, 41″.

A panel 12′ is ready for assembly once the desired number of clips 14′ (preferably two) are attached and spaced such that they 14′ don't interfere with the positioning of clips 14″ on any of the other panels 12″ to be joined. If, in assembly, the clips 14 are in an interfering position, the clips 14 can be easily pushed up or down along the panel's 12 edge 44 to a non-interfering position. As discussed above, friction preferably holds the clip 14 in position. Full height panels 12 (e.g., when used in office spaces of residential purposes) will generally require three hinge clips 14 per panel 12 edge 44.

Additionally, the panels 12, FIG. 8B, may include one or more apertures 101 disposed proximate the edge 44. According to this embodiment, the clips 14 also include apertures 102 within the arms 18. The clips 14 are aligned along the edge 44 of the panel 12 such that the apertures 101 and 102 are aligned to form a passageway. A pin or rod 103 is then slid through the apertures 102, 103. Optionally, a cotter pin 104 or the like is used to ensure that the pin 103 does not accidentally slide out of the apertures 102, 103. This embodiment is particularly useful when the hinge/building system 10 is used with larger panels 12. While the apertures 102 are shown disposed through the engagement device 40, the apertures 102 may be disposed anywhere on clips 14.

The panels 12 are preferably rectangular in shape, though this is not a limitation of the present invention and may include, but is not limited to, circles, hexagons, parallelograms, trapezoids, and the like. The panels 12 can be various sizes (i.e., length, width, and thickness) depending upon the implementation of the hinge system 10. For example, when the hinge system 10 is used as a children's toy (e.g., a doll house or a fortress), the panels 12 preferably include “Easy Reach” walls having a height of approximately 8″, mid-sized walls having a height of approximately 12″, and full height walls having a height of approximately 16″ to match room scale for 11½″ dolls. While not a limitation of the present invention, it has been observed that children are comfortable with walls shorter than their dolls/action figures and prefer the ease of using 8″ walls to reach over the top to set furnishings in place and move dolls through the rooms. The panels 12 may include any width, but preferably range up to 20″ in 4″ increments to add flexibility in room-size design. Smaller widths can also be used to build interior spaces within rooms (i.e., nooks, closets).

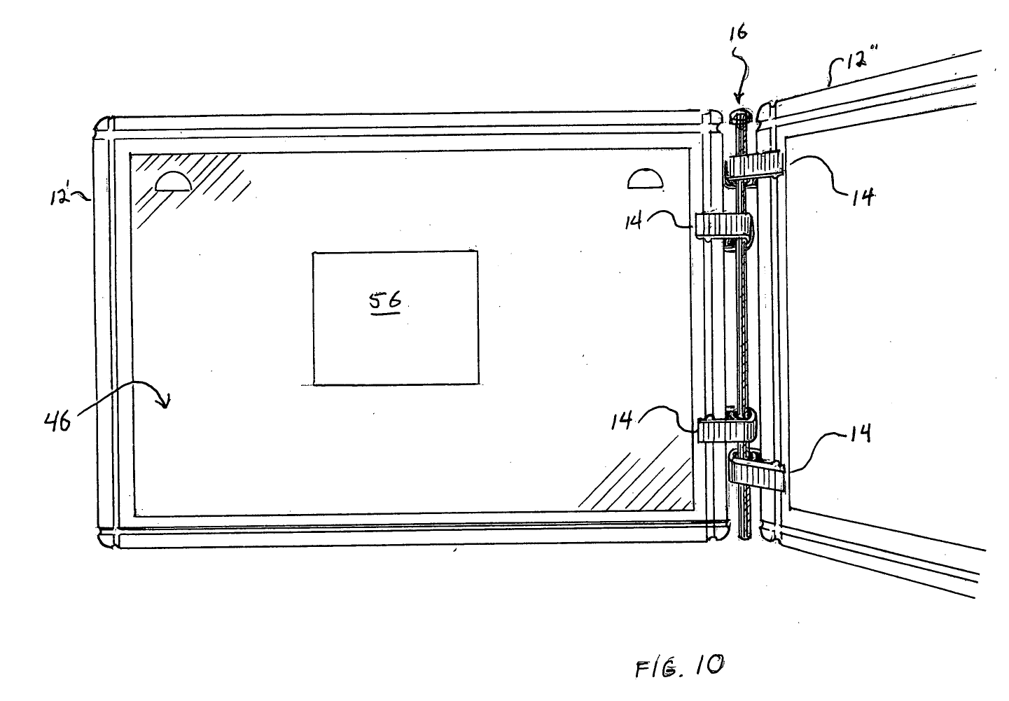

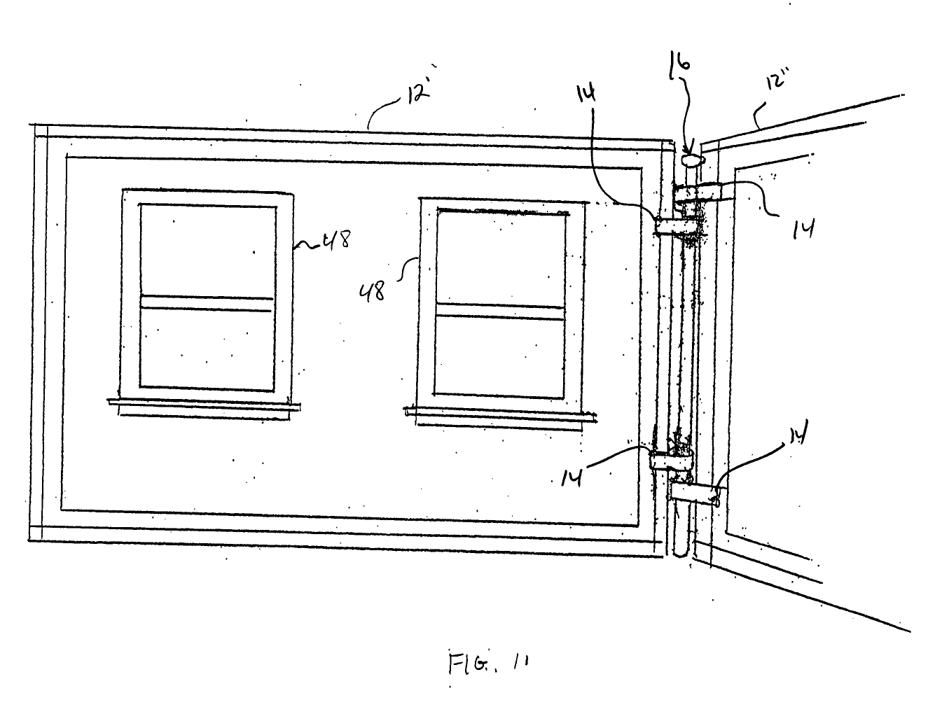

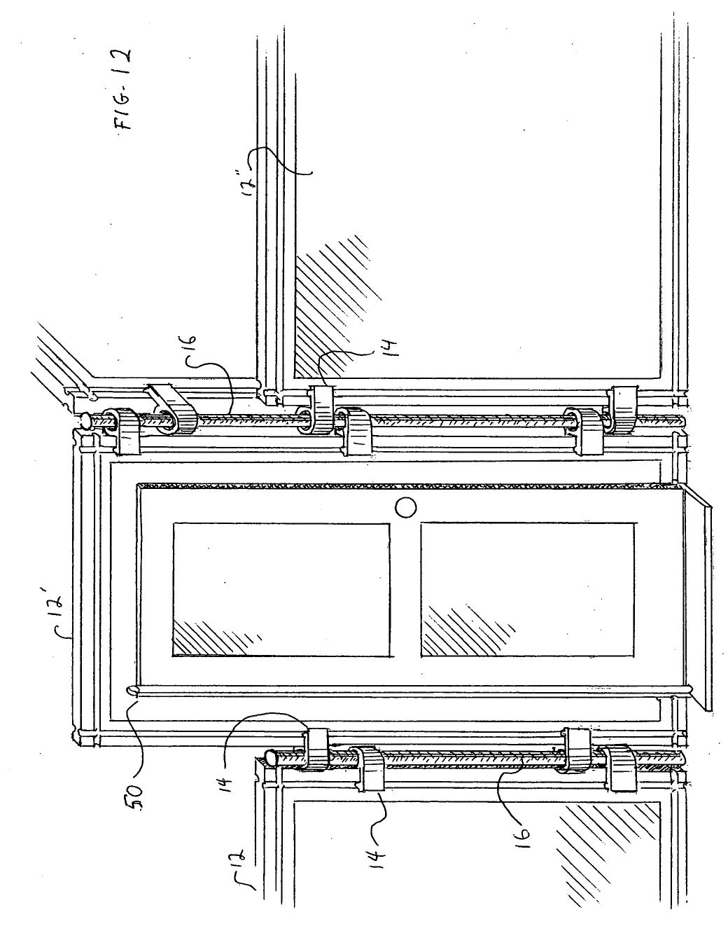

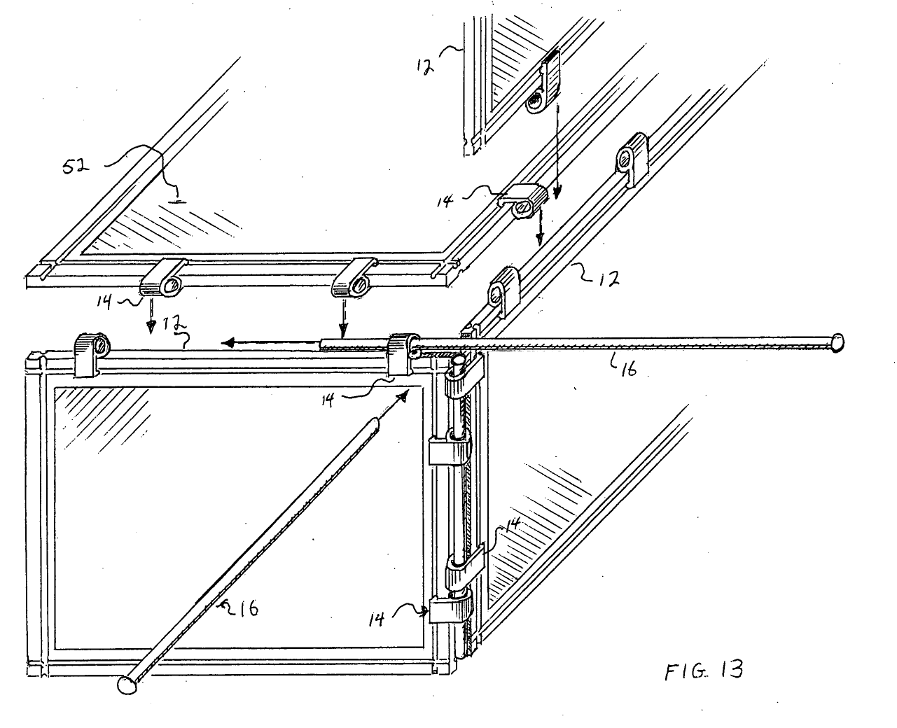

In addition, panels 12 may include an outer surface 46, FIG. 10, having a plain panel, push pin-board, which is capable of being distinguished as an interior and/or exterior surface 46. The present invention may also include an optional accessory system. The accessory system includes certain directly attachable decorating elements 56 and interior and exterior wall treatments to add realism to playtime. For example, these include, but are not limited to, picture frames (glue on your own pictures), hinged fences, and snap, tuck, or other adhesion materials in interior wall coverings, and exterior finishes. Other features may include a garage door, footpaths, and a driveway. Another feature may include a camouflage roof netting for draping over wall structures for military playing. Moreover, the panels 12 may include one or more windows, openings, or skylights 48, FIG. 11, or hinged door/wall sections 50, FIG. 12. The panels 12 may not only form walls, but may also form ceilings or floors 52.

It is important to note that the hinge system 10 according to the present invention may be used for both children's toys as well as commercial (e.g., office space) and residential (e.g., changing rooms).

Modifications and substitutions by one of ordinary skill in the art are considered to be within the scope of the present invention, which is not to be limited except by the following claims.

The invention claimed is:

1. A hinge kit comprising:
a panel, said panel having a first engagement device disposed proximate at least one edge;
a clip having a cavity and a base forming at least two arms extending outwardly therefrom, said at least two arms defining a channel sized and shaped to accept at least a portion of said panel and including a second engagement device disposed proximate a distal end of said at least two arms wherein said first and said second engagement device are adapted to removably engage each other such that when said portion of said panel is disposed within said channel, said clip is secured to at portion of said panel; and
a rod sized and shaped to fit within said cavity of said clip.

2. The hinge kit as claimed in claim 1 wherein said first and said second engagement device includes a friction connection.

3. The hinge kit as claimed in claim 2 wherein said first and said second engagement device includes a groove and a tab.

4. The hinge kit as claimed in claim 3 wherein said first engagement device includes said groove and said second engagement device includes said tab.

5. The hinge kit as claimed in claim 4 wherein said groove is disposed substantially along said entire perimeter of said panel.

6. The hinge kit as claimed in claim 4 wherein said first engagement includes a plurality of engagement devices.

7. The hinge kit as claimed in claim 6 wherein said plurality of engagement devices include a plurality of grooves disposed along at least a portion of said panel.

8. The hinge kit as claimed in claim 3 wherein said first engagement device includes said tab and said second engagement device includes said groove.

9. The hinge kit as claimed in claim 1 wherein said first and said second engagement device include a magnetic connection.

10. The hinge kit as claimed in claim 1 wherein said at least two arms includes at least four arms defining a first and a second arm portion having a first and a second channel respectively.

11. The hinge kit as claimed in claim 10 wherein said first and said second arm portion are fixed at an angle with respect to each other.

12. The hinge kit as claimed in claim 10 wherein said first and said second arm portion are pivotably disposed with respect to each other.

13. The hinge kit as claimed in claim 1 wherein said channel converges proximate said distal ends of said at least two arms such that when said panel is disposed within said channel, said distal ends of said arms are expanded and create a biasing force against said panel.

14. The hinge kit as claimed in claim 1 wherein said rod includes a shaft having a head disposed proximate a first end.

15. The hinge kit as claimed in claim 1 wherein said base defines said cavity.

16. The hinge kit as claimed in claim 1 wherein said base is open to said channel and wherein said cavity includes a space between said base and said panel.

17. The hinge kit as claimed in claim 1 wherein said panel include at least one opening.

18. The hinge kit as claimed in claim 1 wherein panel opening includes a door.

19. The hinge kit as claimed in claim 1 wherein panel opening includes a window.

20. The hinge kit as claimed in claim 1 wherein said hinge kit includes a plurality of panels, a plurality of clips, and a plurality of rods adapted to form a children's toy.

21. The hinge kit as claimed in claim 1 wherein said hinge kit includes a plurality of panels, a plurality of clips, and a plurality of rods adapted to form a cubicle.

22. The hinge kit as claimed in claim 1 wherein at least one of said arms is longer than another arm.

23. The hinge kit as claimed in claim 1 wherein said kit includes at least two rods, wherein a first end of a first rod is adapted to be connected to a second end of a second rod.

24. The hinge kit as claimed in claim 23 wherein said first end of said first rod includes a cavity sized and shaped to accept at least a portion of said second end of said second rod.

25. The hinge kit as claimed in claim 23 further including at least one rod connector having at least one cavity sized and shaped to accept at least a portion of said first and said second ends of said rods.

26. The hinge kit as claimed in claim 1 wherein said second engagement device of said plurality of clips is adapted to slide longitudinally along said edge within said first engagement device.

27. The hinge kit as claimed in claim 1 wherein said clip and said edge of said panel each include at least one aperture positioned such that said apertures form a passageway sized and shaped to accept at least one pin.

28. A hinge clip for a hinge with between at least two panels, said hinge clip comprising a base forming at least two arms extending therefrom, said at least two arms forming a channel sized and shaped to accept at least a portion of at least one panel and including a first engagement device disposed proximate a distal end of said at least two arms, said first engagement device adapted to be removably engaged with a second engagement device disposed on each of said panels said portion of said panel is disposed within said channel.

29. The hinge clip as claimed in claim 28 wherein said first engagement device includes a friction connection.

30. The hinge clip as claimed in claim 29 wherein said first engagement device includes a protrusion.

31. The hinge clip as claimed in claim 28 wherein said channel converges proximate said distal ends of said at least two arms such that when said panel is disposed within said channel, said distal ends of said arms are expanded and create a biasing force against said panel.

32. The hinge clip as claimed in claim 28 wherein said clip further includes a cavity sized and shaped to accept a rod.

33. The hinge clip as claimed in claim 32 wherein said base defines said cavity.

34. The hinge clip as claimed in claim 32 wherein said base is open to said channel and wherein said cavity includes a space between said base and said panel.

35. The hinge clip as claimed in claim 28 wherein at least one of said arms is longer than another arm.

36. A children's toy kit for forming a structure having at least two sides, said kit comprising:
a plurality of panels, each panel including a first engagement device disposed proximate at least one edge;
a plurality of clips, each clip including a cavity and base having at least two flanges extending outwardly and forming a channel sized and shaped to accept at least a portion of at least one panel wherein at least one flange includes a second engagement device adapted to be removably engage with said first engagement device; and
a plurality of rods sized and shaped to fit within said cavity of at least two clips.

37. The kit as claimed in claim 36 wherein said second engagement device of said plurality of clips is adapted to slide longitudinally along said edge within said first engagement device.

38. The kit as claimed in claim 36 wherein said kit includes at least two rods, wherein a first end of a first rod is adapted to be connected to a second end of a second rod.

39. The kit as claimed in claim 38 wherein said first end of said first rod includes a cavity sized and shaped to accept at least a portion of said second end of said second rod.

40. The kit as claimed in claim 38 further including at least one rod connector having at least one cavity sized and shaped to accept at least a portion of said first and said second ends of said rods.
